(19) United States
(12) Patent Application Publication
(10) Pub. No.: US 2016/0150034 A1
(43) Pub. Date: May 26, 2016

(54) SYSTEM, METHOD AND COMPUTER PROGRAM PRODUCT FOR LOCATING MEMBERS OF A CROWD AND CONTROLLING INTERACTIONS THEREWITH

(71) Applicant: 9178066 Canada Inc, Sherbrooke (CA)

(72) Inventors: Claude CARON, Sherbrooke (CA); Daniel CHAMBERLAND-TREMBLAY, Sherbrooke (CA)

(21) Appl. No.: 14/943,064

(22) Filed: Nov. 17, 2015

Related U.S. Application Data
(60) Provisional application No. 62/083,349, filed on Nov. 24, 2014.

(51) Int. Cl. H04L 29/08; H04L 12/24; H04W 4/02

(52) U.S. Cl. CPC H04L 67/18; H04W 4/023; H04L 41/22; H04L 67/10; H04W 84/18

(57) ABSTRACT

Infrastructure for locating members of a crowd and controlling interactions with them. A control system stores a scenario, comprising at least one step, for interacting with the crowd. The control system receives location data from a plurality of handheld computing devices of the crowd, and data representative of interactions with the crowd. The control system processes the location data and a specific step of the scenario, to generate a command for interacting with the crowd, and to further identify specific handheld computing devices for applying the command. The control system further transmits the command to the specific handheld computing devices. The control system also processes the data representative of the interactions with the crowd. The specific handheld computing devices process the command to actuate themselves for interacting with the crowd. The handheld computing devices also transmit data representative of interactions with the crowd to the control system.

### TECHNICAL FIELD

The present disclosure relates to the field of interactive audience participation. More specifically, the present disclosure presents a system, method and computer program product for locating members of a crowd and controlling interactions therewith.

### BACKGROUND

An audience is constituted of the assembled spectators or listeners present at an event. The audience of an event may seek a solemn purpose such as a business meeting, a conference or a lecture. Alternatively, the audience participating at an event may seek entertainment purposes such as a play, a movie, a sports event or a concert. During entertaining events, the audience usually expects a certain level of interaction with at least the performer of the event or with the other spectators.

Involving an audience in an interactive and shared experience has been practiced by different types of performers. Nowadays, technologies are playing a role in involving audiences. For example, the implementation of mobile technologies for interacting with an audience is presently used. More specifically, dedicated mobile computing devices enable a large audience to share the experience of playing computer generated games. These games can involve, for example, controlling a ball projected on a display facing the spectators, the ball being controlled by the synchronized movement of the body of each spectator of the audience. Although quite entertaining, the technology involved is very limited in the precision of the patterns that can be detected: it can only detect wide synchronized movement of a large portion of the audience.

Another example of an interactive and shared experience is combining small displays (such as of handheld computing devices like mobile devices) to form a larger display exhibiting a specific shape, an artwork or an animation. The complexity of the patterns exhibited on the larger display is currently limited by the level of interactions with the crowd. For instance, the technologies used for controlling the interactions do not allow to control interactions with a specific member of the crowd, or a small group of members of the crowd. Furthermore, the technologies used are limited with respect to the feedbacks that can transmitted from the members of the crowd to a system in charge of executing a scenario for interacting with the crowd.

Therefore, there is a need for a new system, method and computer program product for locating members of a crowd and controlling interactions therewith.

### SUMMARY

According to a first aspect, the present disclosure presents a system for locating members of a crowd and controlling interactions therewith. The system comprises memory for storing a scenario for interacting with the crowd, the scenario comprising at least one step. The system comprises a communication interface for receiving location data from a plurality of handheld computing devices of the crowd, and for receiving data representative of interactions with the crowd. The system comprises a processing unit for processing the location data and a specific step of the scenario. The processing generates a command for interacting with the crowd, and identifies specific handheld computing devices among the plurality of handheld computing devices for applying the command. The processing unit also transmits the command to the specific handheld computing devices via the communication interface. The processing unit further processes the data representative of the interactions with the crowd.

According to a second aspect, the present disclosure presents a method for locating members of a crowd and controlling interactions therewith. The method comprises storing, at a memory, a scenario for interacting with the crowd, the scenario comprising at least one step. The method comprises receiving location data from a plurality of handheld computing devices of the crowd. The method comprises processing, by a processing unit, the location data and a specific step of the scenario. The processing generates a command for interacting with the crowd, and identifies specific handheld computing devices among the plurality of handheld computing devices for applying the command. The method comprises transmitting the command to the specific handheld computing devices. The method also comprises receiving data representative of interactions with the crowd. The method further comprises processing, by the processing unit, the data representative of the interactions with the crowd.

According to a third aspect, the present disclosure presents a computer program product comprising instructions deliverable via an electronically-readable media, such as storage media and communication links, which when executed by a processing unit of a handheld computing device provide for locating members of a crowd and controlling interactions therewith. The instructions effect a determination of location data of the handheld computing device. The instructions effect a transmission of the location data to a control system. The instructions also effect a reception of a command for interacting with the crowd from the control system. The instructions effect a processing of the command to actuate the handheld computing device for interacting with the crowd. The instructions further effect a collection of data representative of interactions with the crowd. The instructions effect a transmission of the data representative of the interactions with the crowd to the control system.

### BRIEF DESCRIPTION OF THE DRAWINGS

Embodiments of the disclosure will be described by way of example only with reference to the accompanying drawings, in which:

FIG. 1 represents an exemplary diagram of a control system for locating members of a crowd and controlling interactions therewith;

FIG. 2 represents an exemplary diagram of a handheld computing device for locating members of a crowd and controlling interactions therewith;

FIGS. 3A, 3B and 3C represent three examples of interactions between the control system of FIG. 1 and the handheld computing device of FIG. 2;

FIG. 4A represents a plurality of the handheld computing devices of FIG. 2 communicating with respective beacons;

FIG. 4B represents a plurality of the handheld computing devices of FIG. 2, where only one handheld computing device is communicating with a beacon;

FIG. 5A represents a cluster constituted of five handheld computing devices of FIG. 2;

FIGS. 5B and 5C represent intersections between several clusters as illustrated in FIG. 5;

FIG. 6 represents a method for locating members of a crowd and controlling interactions therewith implemented by the control system of FIG. 1;

FIG. 7 represents a method for locating members of a crowd and controlling interactions therewith implemented by the handheld computing device of FIG. 2; and

FIG. 8 represents software components executed by the handheld computing device of FIG. 2 for implementing the method of FIG. 7.

### DETAILED DESCRIPTION

The foregoing and other features will become more apparent upon reading of the following non-restrictive description of illustrative embodiments thereof, given by way of example only with reference to the accompanying drawings.

Various aspects of the present disclosure generally address one or more of the problems related to locating members of a crowd and controlling interactions therewith by means of a centralized control system and a plurality of handheld computing devices owned by the members of the crowd.

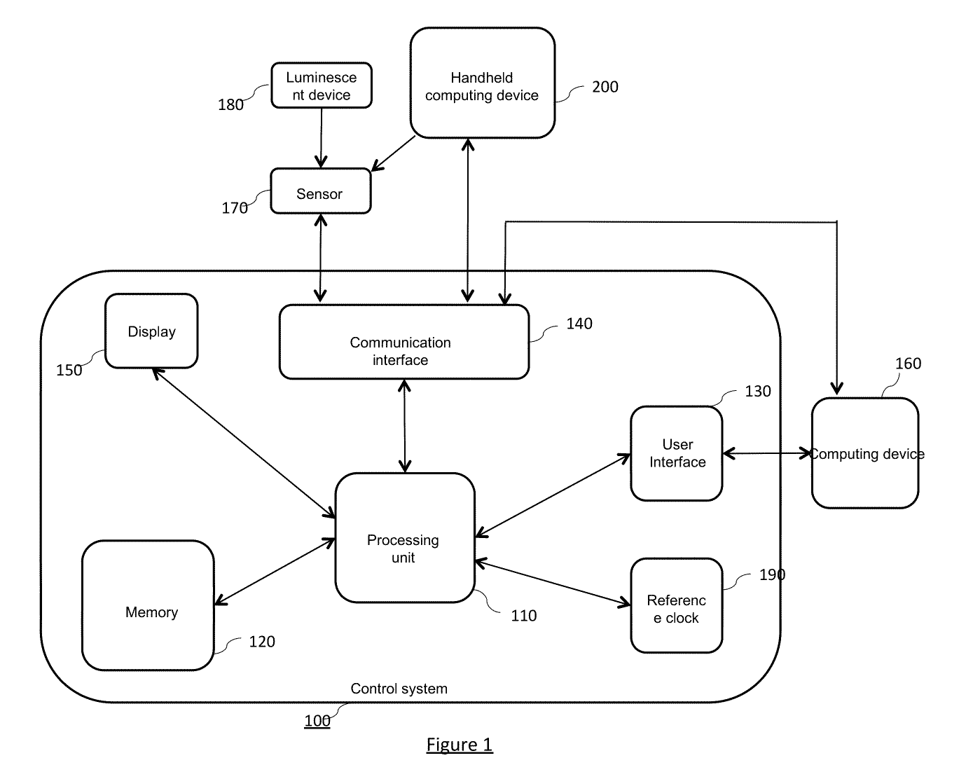

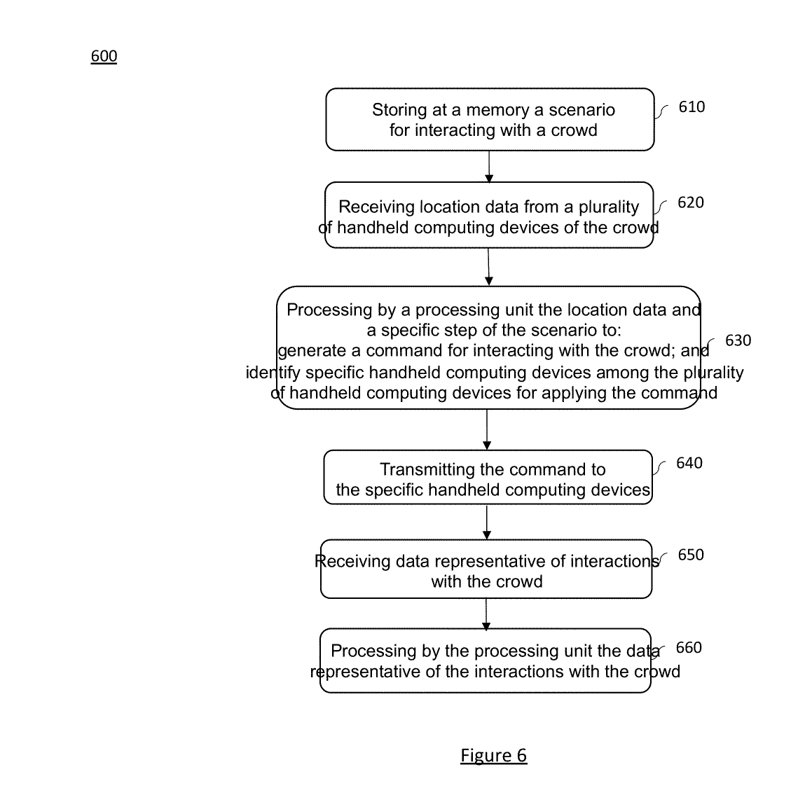

Referring now concurrently to FIGS. 1, 2 and 6, a control system 100, a handheld computing device 200, and a method 600 executed by the control system 100 for locating members of a crowd and controlling interactions therewith are represented.

The control system 100 comprises a processing unit 110, a memory 120, optionally a user interface 130, optionally a display 150, a communication interface 140, and optionally a reference clock 190.

The processing unit 110 has one or more processors (not represented in FIG. 1) capable of executing instructions of a computer program. Each processor may further have one or several cores.

The memory 120 stores instructions of computer program(s) executed by the processing unit 110, data generated by the execution of the computer program(s), data received via the communication interface 140, etc. Only a single memory 120 is represented in FIG. 1, but the control system 100 may comprise several types of memories, including volatile memory (such as a volatile Random Access Memory (RAM)) and non-volatile memory (such as a hard drive).

A single display 150 is represented in FIG. 1, however the control system 100 may comprise several displays. At least some of the displays may have a large screen, to be visible by a large crowd. Some of the displays may be far from the control system 100, and may receive data to be displayed via the communication interface 140 of the control system 100 (e.g. over an Ethernet or Wi-Fi network). As mentioned previously, the display 150 is optional and the control system 100 may comprise no display.

The communication interface 140 allows the control system 100 to exchange data with the handheld computing devices 220, and optionally with other computing devices 160 (e.g. over an Ethernet or Wi-Fi network). The communication interface 140 supports at least some of the following mobile communication technologies for exchanging data with the handheld computing devices 200: cellular network, Wi-Fi network, mesh network, a combination thereof, etc.

The method 600 comprises the step 610 of storing in the memory 120 a scenario for interacting with the crowd. The scenario comprises at least one step, each step representing a particular sequence of the whole interactive scenario. For example, the scenario may be a choreography decomposed into a plurality of steps. The execution of the scenario by the control system 100 may result in displaying an artwork, an animation, etc. on the display 150, based on the interactions with the crowd. The objective is to integrate in real time the interactions with the crowd to an event or a show attended by the crowd.

The control system 100 may receive via the communication interface 140 the scenario for interacting with a crowd. The scenario is initially stored in a computing device 160 (where it has been generated by a user of the computing device 160), and transferred to the control system 100 via the communication interface 140. Alternatively, the scenario may be generated directly at the control system 100 by a user via the user interface 130 (e.g. a keyboard, a mouse, a touchscreen, etc.). The user interface 130 can also be used to control the execution of the scenario by the control system 100 (e.g. replaying the same scenario a second time, skipping a particular step of the scenario, replaying a particular step of the scenario, etc.).

The method 600 comprises the step 620 of receiving location data from a plurality of handheld computing devices 200 of the crowd, via the communication interface 140. The location data transmitted by a particular handheld computing device 200 comprise a location of this particular handheld computing device 200.

The method 600 comprises the step 630 of processing by the processing unit 110 the location data and a specific step of the scenario. The processing step 630 comprises generating a command for interacting with the crowd, the command being representative of an action to be performed by members of the crowd according to the specific step of the scenario. Examples of commands will be given later in the description. The processing step 630 further comprises identifying specific handheld computing devices 200 among the plurality of handheld computing devices for applying the command. The specific handheld computing devices 200 are identified based on their location data, so that the command is performed by devices 200 belonging to members of the crowd located at a particular position corresponding to the location data. The particular position for executing the command is defined in the specific step of the scenario. A particular command is directed to several specific handheld computing devices 200, so that the several specific handheld computing devices 200 execute the same command substantially at the same time. However, a particular command may be directed to a single handheld computing device 200. Furthermore, the specific step of the scenario may include several different commands, each different command being performed in parallel or in sequence by one or several handheld computing devices 200.

The method 600 comprises the step 640 of transmitting the command to the specific handheld computing devices 200.

The method 600 comprises the step 650 of receiving by the control system 100 via the communication interface 140 data representative of interactions with the crowd. The data representative of the interactions with the crowd are representative of actions performed by members of the crowd, based on commands received by their handheld computing device 200. The commands correspond to the current step of the scenario and/or a previous step of the scenario.

The data representative of interactions with the crowd may be received from the plurality of handheld computing device 200. The data representative of the interactions with the crowd may include, without limitations, at least one of the following: data from an accelerometer of a particular handheld computing device 200 (representative for example of the particular handheld computing device 200 being shaken or lifted), a recording by a microphone (not represented in the Figures) of a particular handheld computing device 200 (e.g. a recording of a scream of a user of the particular handheld computing device 200).

Alternatively or complementarily, the data representative of interactions with the crowd are received from at least one sensor 170. For example, the sensor(s) 170 may be camera(s) capturing patterns displayed on the displays 250 of the handheld computing devices 200. The camera(s) 170 may also capture light patterns of luminescent devices 180 (e.g. luminescent sticks) agitated by owners of the handheld computing devices 200. The camera 170 may also simply capture movements of the members of the crowd (e.g. agitating their arms simultaneously, performing a progressive wave by standing up and down, etc.). The luminescent device 180 represented in FIG. 1 is for illustration purposes only. Any other complementary device 180 capable of generating a signal (e.g. light, short range radio signal, sound, etc.) that can be captured by an appropriate sensor 170 may be used. The cameras may be on a stage where a show is being performed for the crowd. The cameras may also be positioned at the top of a structure; or may be carried by inflated balloons, drones, etc. Elevated cameras allow to easily capture actions of members of the crowd, such as agitating their arms, standing up or down, agitating their arms holding the handheld computing devices 200, etc.

The method 600 comprises the step 660 of processing by the processing unit 110 the data representative of the interactions with the crowd. For instance, processing the data representative of the interactions with the crowd comprises generating a visual representation of the interactions with the crowd. The visual representation may be further displayed on the display 150. The visual representation can be integrated to a media content already displayed on the display 150, as part of a show presented to the crowd. Although the control system 100 is represented with a single display 150, it may comprise several displays 150 for displaying the visual representation. Furthermore, the display(s) 150 may be integrated to the control system 100 as illustrated in FIG. 1, or may be remote displays (e.g. dispatched at several locations for being visible to the entire crowd) which can be accessed by the control system 100 via its communication interface 140. Alternatively, the visual representation is displayed directly on the crowd, for instance with a laser or a projector.

Examples of visual representations generated by the processing unit 110 include a static image representative of certain members of the crowd agitating their handheld computing devices 200 simultaneously, a dynamic image representative of certain members of the crowd agitating their handheld computing devices 200 alternatively to represent a directed wave in the crowd, a game controlled by interactions with the crowd such as displaying a virtual beach ball being moved based on movements of the handheld computing devices 200 of the crowd, etc.

In a particular aspect, a command generated by the processing unit 110 for interacting with the crowd may be displayed on the display(s) 150, instead of being transmitted to selected handheld computing devices 200. This may be the case if the command addresses the totality of the crowd (or a large and easily identifiable part of the crowd, such as for example the front rows or back rows of an audience). For instance, the command displayed on the display(s) 150 may request the whole crowd to stand up or sit down. One or several specific steps of the scenario may result in a command being generated and displayed on the display(s) 150, while for other steps of the scenario the commands are generated and transmitted to selected handheld computing devices 200.

In another particular aspect, instructions of a specific computer program implement the steps of the method 600. The instructions are comprised in a computer program product and provide for locating members of a crowd and controlling interactions therewith, when executed by the processing unit 110 of the control system 100. The computer program product is deliverable via an electronically-readable media such as a storage media (e.g. CD-ROM, USB key, etc.) or via communication links (e.g. Ethernet link, Wi-Fi network, cellular network) through the communication interface 140.

Referring now concurrently to FIGS. 1, 2 and 7, the control system 100, the handheld computing device 200, and a method 700 executed by the handheld computing device 200 for locating members of a crowd and controlling interactions therewith are represented.

The handheld computing device 200 comprises a processing unit 210, a memory 220, a user interface 230, a communication interface 240, a display 250, optionally an accelerometer 260, and optionally a clock 290.

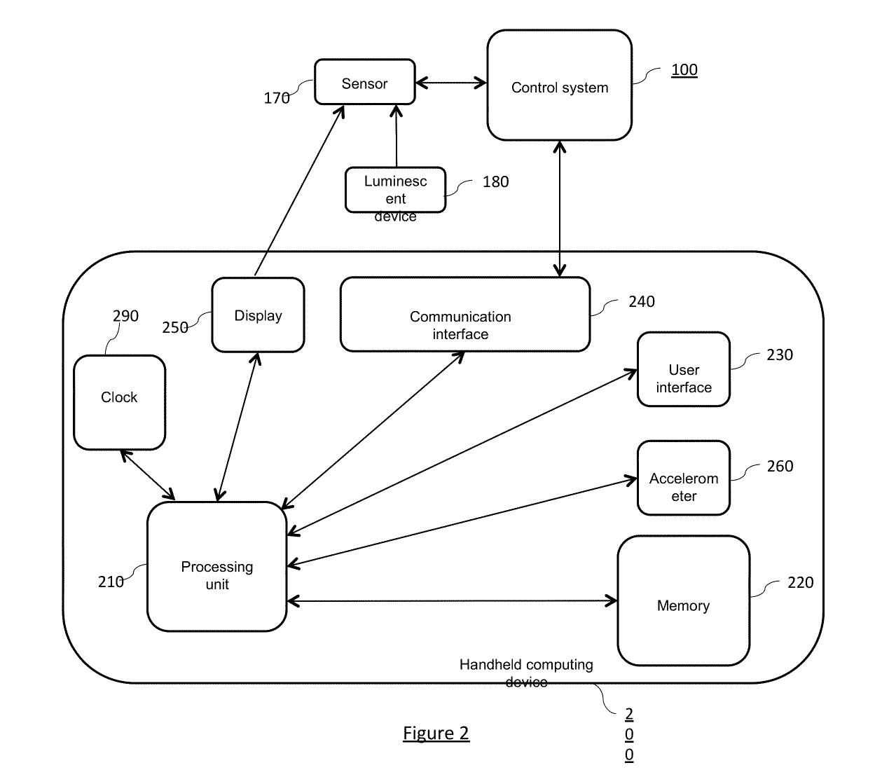

The processing unit 210 has one or more processors (not represented in FIG. 2) capable of executing instructions of a computer program. Each processor may further have one or several cores.

The memory 220 stores instructions of computer program(s) executed by the processing unit 210, data generated by the execution of the computer program(s), data received via the communication interface 240, data generated by the accelerometer 260, etc. Only a single memory 220 is represented in FIG. 2, but the handheld computing device 200 may comprise several types of memories, including volatile memory (such as a volatile Random Access Memory (RAM)) and non-volatile memory (such as a hard drive).

The communication interface 240 allows the handheld computing devices 220 to exchange data with the control system 100. As mentioned previously, the communication interface 240 supports at least some of the following mobile communication technologies for exchanging data with the control system 100: cellular network, Wi-Fi network, mesh network, ad-hoc network, a combination thereof, etc.

The accelerometer 260 measures the physical acceleration of the handheld computing device 200, allowing determination of movements of the handheld computing device 200.

Examples of handheld computing devices 200 include, without restrictions, a smartphone, a tablet, a fablet, a smart watch, etc. The user interface 230 comprises at least one of the following: a keyboard, a touchscreen, etc.

Reference is now made to instructions of a specific computer program. The instructions of the specific computer program implement the steps of the method 700. The instructions are comprised in a computer program product and provide for locating members of a crowd and controlling interactions therewith, when executed by the processing unit 210 of the handheld computing device 200. The computer program product is deliverable via an electronically-readable media such as a storage media (e.g. CD-ROM, USB key, etc.) or via communication links (e.g. Wi-Fi network, cellular network) through the communication interface 240.

The method 700 comprises the step 710 of determining, by the processing unit 210, location data of the handheld computing device 200. For instance, a location engine executed by the processing unit 210 may implement a dedicated algorithm for determining coordinates of the handheld computing device 200 and the location thereof. The location engine may implement a particular algorithm (selected among a plurality of available algorithms) in relation with data received, without limitations, from at least one of the following: a Global Positioning System (GPS), a Wireless Local Area Network (e.g. Wi-Fi, Bluetooth, Bluetooth Low Energy), a mobile network (e.g. EDGE, 3G, 4G, LTE). The determination of the location data will be detailed later in the description.

The method 700 comprises the step 720 of transmitting the location data to the control system 100, via the communication interface 240.

The method 700 comprises the step 730 of receiving, via the communication interface 240, a command for interacting with the crowd from the control system 100.

The method 700 comprises the step 740 of processing the command by the processing unit 210 to actuate the handheld computing device 200 for interacting with the crowd.

Actuating the handheld computing device 200 for interacting with the crowd may comprise displaying the command on the display 250 of the handheld computing device 200. The command comprises one or more actions to be performed by the owner of the handheld computing device 200, such as standing up, agitating an arm, standing up and agitating an arm, etc. The action may also consist in actuating a complementary device (e.g. a luminescent device) 180, as illustrated previously in the description. Alternatively or complementarity, actuating the handheld computing device 200 for interacting with the crowd comprises activating a component of the handheld computing device 200. Activated components of the handheld computing device 200 may comprise, without limitations, a vibrator, the accelerometer 260, a flash, a microphone, the display 250 (e.g. by displaying a specific pattern on the display 250 which can be captured by the camera 170), etc.

The method 700 comprises the step 750 of collecting data representative of interactions with the crowd. The data representative of interactions with the crowd may comprise, without limitations, data generated by the accelerometer 260 and representative of a movement of the handheld computing device 200, a sound recorded by the microphone, etc.

The method 700 comprises the step 760 of transmitting, via the communication interface 240, the data representative of the interactions with the crowd to the control system 100.

In a particular aspect, at least one step of the scenario comprises a time reference, and the time reference is transmitted with the command from the control system 100 to the handheld computing devices 200. The actuation of a handheld computing device 200 receiving a command for interacting with the crowd with a time reference, is performed based on the time reference. The time reference may be an absolute time reference, so that the actuation of the handheld computing device 200 following the reception of the command is performed at a certain time determined with the clock 290 of the handheld computing device 200. Alternatively, the time reference is a relative time reference, so that the actuation of the handheld computing device 200 following the reception of the command is performed after a certain amount of time has elapsed, the amount of time being determined with the clock 290. Similarly, the data representative of the interactions with the crowd may be transmitted with a time reference (the time at which the interactions occurred) from the handheld computing devices 200 to the control system 100. The transmitted time reference is taken into consideration during the processing of the data representative of the interactions with the crowd by the control system 100. For instance, interactions with the crowd occurring outside of a particular time frame are not taken into consideration by the control system 100.

The processing unit 110 of the control system 100 may further send synchronization messages via the communication interface 140 to the plurality of handheld computing devices 200, for maintaining a synchronization of the clocks 290 of the plurality of handheld computing devices 200 with a reference clock 190 of the control system 100. Although the reference clock 190 and clocks 290 are represented as independent components, they may respectively be integrated to the processing units 110 and 210.

In another particular aspect, each of the plurality of handheld computing devices 200 has a unique identifier. The location data of a particular handheld computing device 200 transmitted by this particular handheld computing device 200 comprises the unique identifier. Thus, upon reception by the control system 100 of the location data comprising the unique identifiers from a plurality of handheld computing devices, the identification of specific handheld computing devices among the plurality of handheld computing devices for applying a command generated by the control system 100 is based on the unique identifiers of the specific handheld computing devices. Similarly, the data representative of interactions with the crowd transmitted by the handheld computing devices 200 to the control system 100 also comprise the unique identifiers. The unique identifiers can be used during the processing by the control system 100 of the data representative of the interactions with the crowd, for instance to filter specific handheld computing devices 200 based on their unique identifier (for instance, handheld computing devices 200 having a particular location are filtered and not taken into consideration). The unique identifier may consist of an existing identifier, such as a Media Access Control (MAC) address, an International Mobile Station Equipment Identity (IMEI) in the case of a mobile device, etc. Alternatively, the unique identifier is generated by the specific computer program executed by the handheld computing devices 200 for locating members of the crowd and controlling interactions therewith.

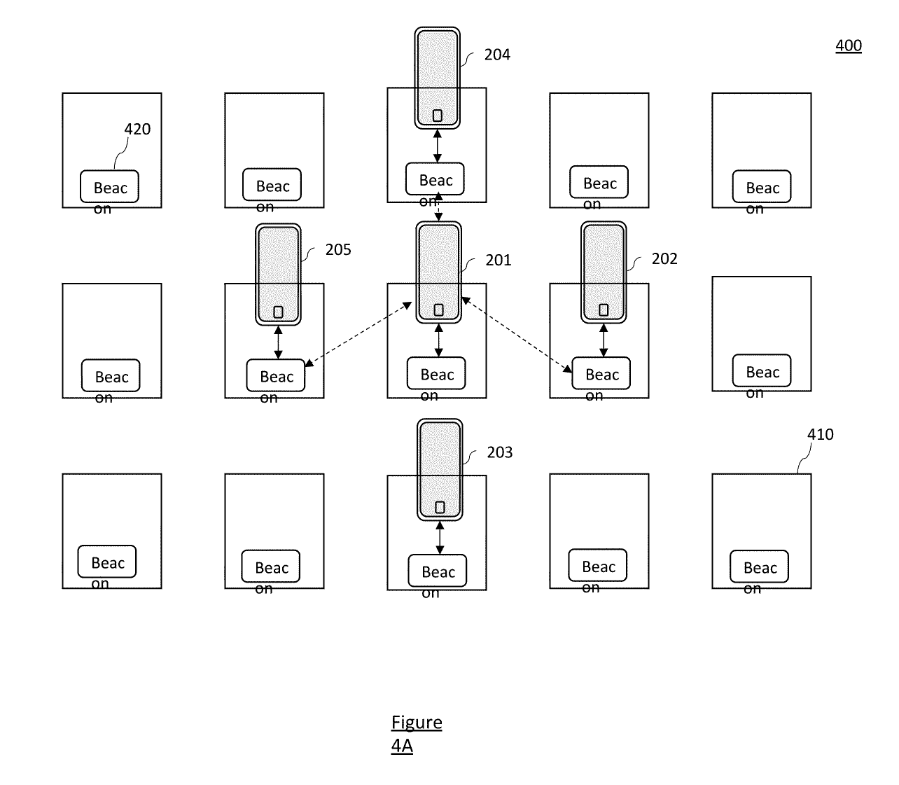

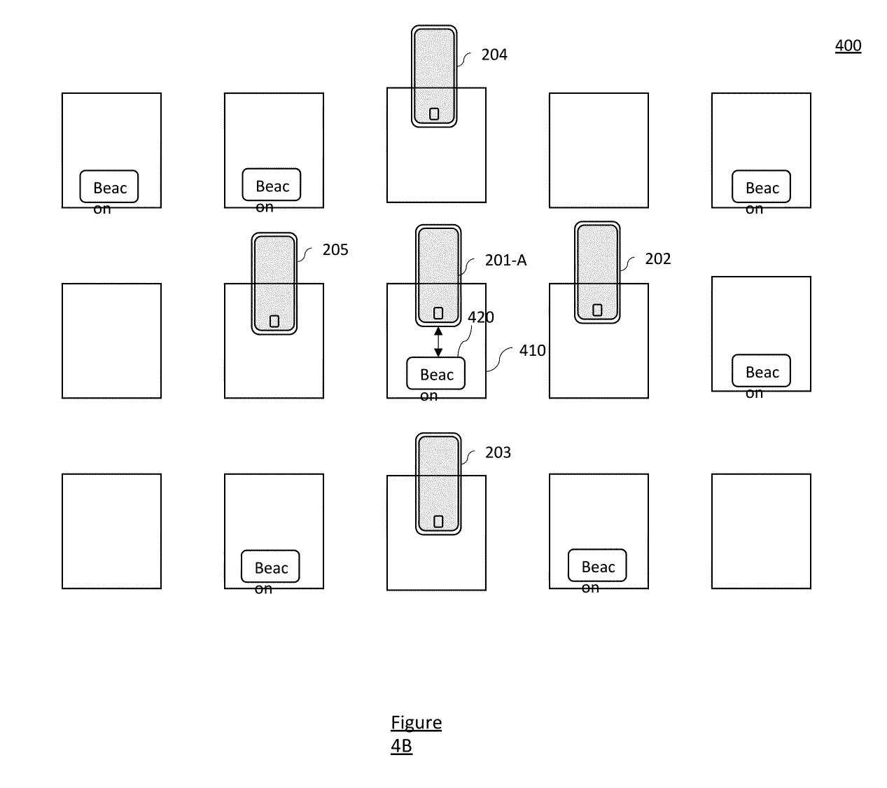

In still another particular aspect, the location data and the data representative of interactions with the crowd (which may include the aforementioned unique identifiers) generated by a plurality of handheld computing devices (e.g. 202, 203, 204 and 205 in FIG. 4B) are consolidated at a particular handheld computing device (e.g. 201-A in FIG. 4B) and transmitted by this particular handheld computing device to the control system 100. The consolidation can be performed by means of a mesh network established between the handheld computing devices (201-A, 202, 203, 204 and 205 in FIG. 4B).

In yet another particular aspect, the generation (by the control system 100) of a command for interacting with the crowd and the identification of the specific handheld computing devices 200 for applying the command may take into consideration the data representative of the interactions with the crowd (transmitted by the specific handheld computing devices 200). For example, the data representative of the interactions with the crowd may consist of data generated by an accelerometer of the handheld computing devices 200 and are representative of a movement of the handheld computing devices 200. For certain handheld computing devices 200 experiencing an upward movement based on the accelerometer data, the command may consist in vibrating the handheld computing devices 200 after a certain delay, to indicate to the owners of these handheld computing devices 200 that they should lower their handheld computing devices 200. For other handheld computing devices 200 experiencing a downward movement based on the accelerometer data, the command may consist in displaying a message on the display of the handheld computing devices 200 after a certain delay, to indicate to the owners of these handheld computing devices 200 that they should lift their handheld computing devices 200 again.

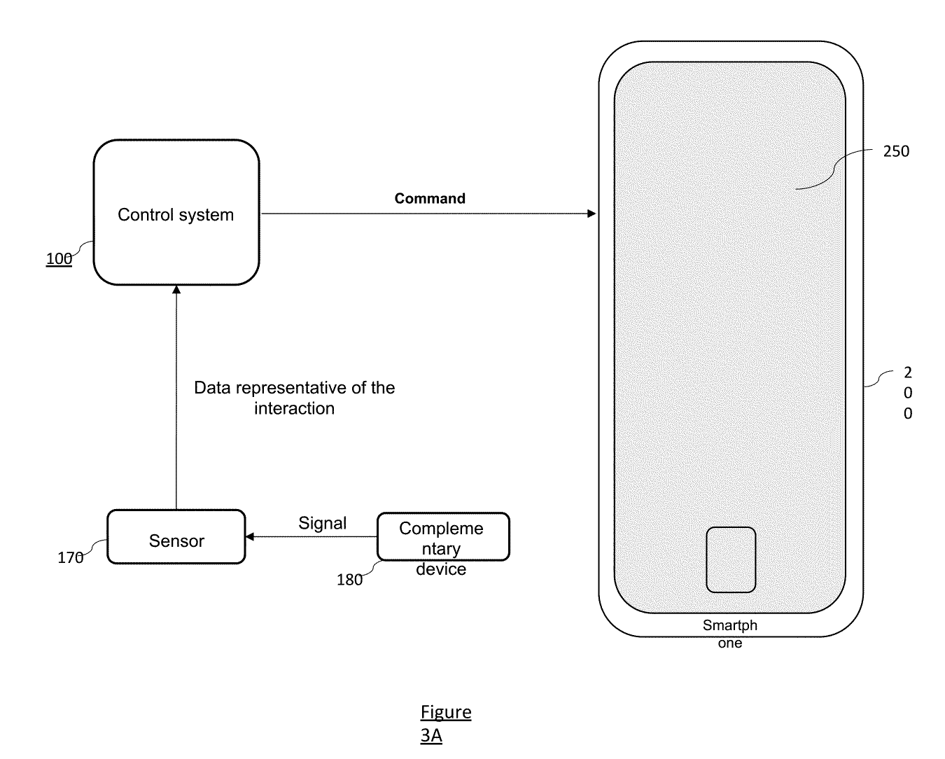

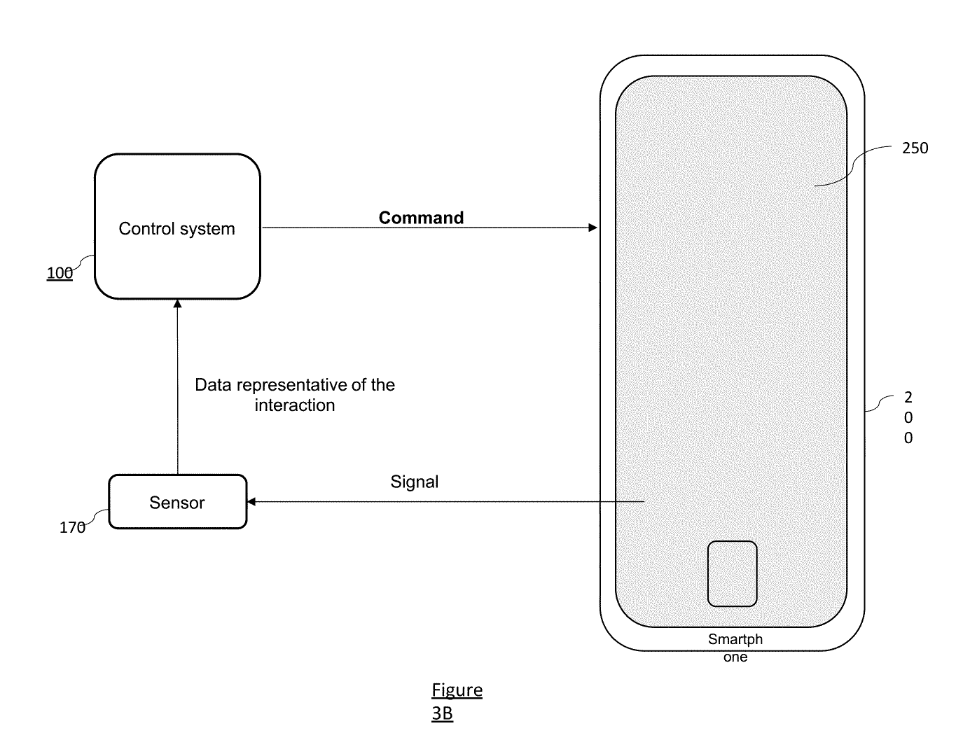

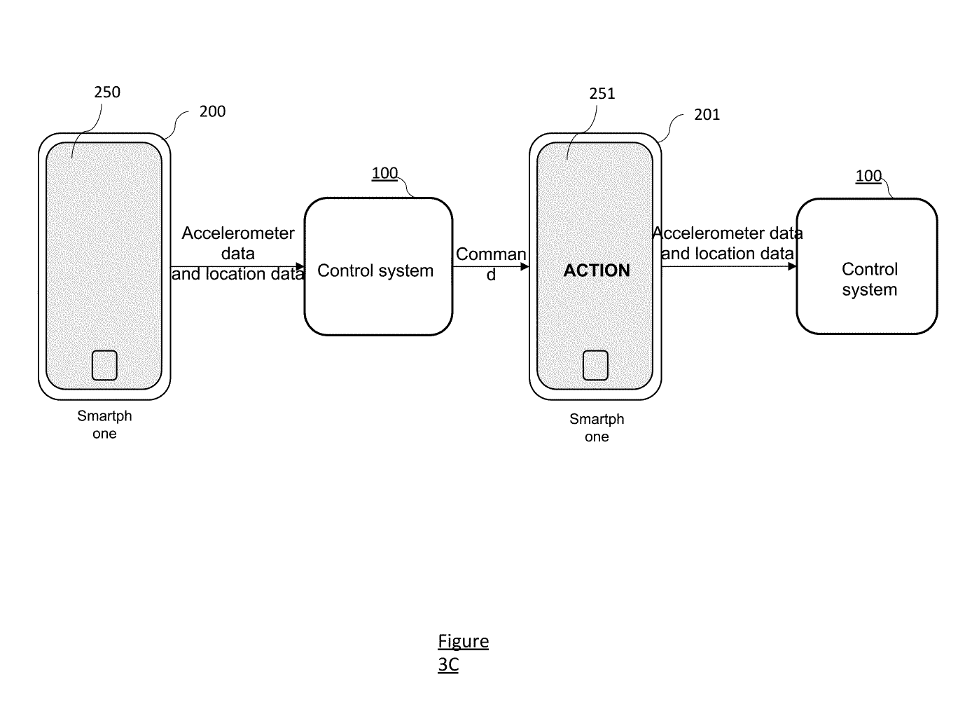

Referring now concurrently to FIGS. 3A and 3B, an exemplary diagram of the interactions between a handheld computing device 200 (for example a smartphone), and the control system 100 is represented. In the present example, the interactions may occur directly between the smartphone 200 and the control system 100 (FIG. 3B), or may involve a complementary device 180 (FIG. 3A). For instance, the present example illustrates the use case of a spectator being part of an audience attending an event. The complementary device 180 represented in FIG. 3A may be attached to a part of the body of the spectator (e.g. to his wrist or his arm), or may be held by the spectator with his hand. The complementary device 180 emits a signal (e.g. light, short range radio signal, sound, etc.) than can be captured by the sensor 170 (e.g. a camera, a short range radio signal detector, a sound recorder, etc.). Alternatively, the whole body or a part of the body (e.g. an arm or the head) of the spectator plays the role of a complementary device emitting a signal (an image of the spectator in this case), which can be captured by a camera 170.

We first consider the case of a complementary device 180 emitting light and attached to a wrist of the spectator (FIG. 3A). The control system 100 sends a command comprising the action of raising the hand holding the complementary device 180 to the smartphone 200. The action is displayed on the display 250 of the smartphone 200. The sensor 170 cannot detect light emitted by the complementary device 180 when the spectator has its hands lowered, which is the normal state of the crowd. However, responding to the action displayed on the display 250, the spectator raises its hand holding the complementary device 180. The sensor 170 receives the signal (light) from the complementary device 180, and transmits the data representative of the interaction (e.g. a conversion of the received signal into digital data) to the control system 100. After a few seconds, the control system 100 may send a new command comprising the action of lowering the hand to the smartphone 200, the action being then displayed on the display 250 of the smartphone 200. Although a single smart phone 200 and a single complementary device 180 are represented in FIG. 3A, the sensor 170 may capture signals generated by a plurality of complementary devices 180 corresponding to a plurality of smartphones 200. Additionally, the data representative of the interactions with multiple smartphones 200 are processed by the control system 100, for example to generate a visual representation based on these data.

A similar scenario is illustrated in FIG. 3B, with the sensor 170 detecting light transmitted from the display 250 of the smartphone 200. The smartphone 200 receives a first command from the control system 100 comprising the action of raising the smartphone 200 with its display 250 facing a stage (where the sensor 170 may be located), the action being displayed on the display 250 of the smartphone 200. The smartphone 200 receives a second command from the control system 100 comprising the action of vibrating the smartphone 200, the action being executed by the smartphone 200. The vibration of its smartphone 200 is interpreted by the spectator as a signal for lowering its smartphone 200, which is then no longer detectable by the sensor 170.

In another example, and referring now concurrently to FIGS. 2 and 3C, a plurality of smartphones 200 belonging to spectators in a crowd send data to the control system 100. The data comprise the location data and the data generated by the accelerometers 260 of the plurality of smartphones 200. The control system 100 receives the data and generates a command based on the processing of a specific step of a scenario. The control system 100 further selects specific smartphones 201 among the plurality of smartphones 200, based on their location data. The command is only transmitted by the control system 100 to the selected smartphones 201. The command comprises the action of standing up for the spectators who receive it via their smartphones 201. The action is displayed on the displays 251 of the selected smartphones 201 upon reception of the command. Afterwards, each smartphone 201 of the spectators who have completed the task of standing up registers data of its accelerometer 260 representative of the standup movements of the spectators. The new data of the accelerometer 260, as well as the location data, of the smartphones 201 are then transmitted to the control system 100. The control system 100 may then inquire the same selected portion of the audience which owns the smartphones 201 to sit down, and another portion of the audience which owns other smartphones 200 to stand up. Repeating this process continuously may result in creating a pattern of a wave passing through the audience. Furthermore, the accelerometer data representative of the standup movements of the spectators and the corresponding location data are processed by the control system 100 to generate a visual representation of the progression of the wave passing through the audience, which can be displayed on large displays visible by the audience.

In the following are described technologies for implementing the step 710 of the method 700, consisting in determining location data of a plurality of handheld computing devices 200. The location data of the plurality of handheld computing devices 200 may consist of two types of data: absolute location data and relative location data. The absolute location data are representative of a fixed spatiotemporal system of coordinates. The relative location data are representative of a position of a particular handheld computing device 200 with respect to at least one other handheld computing device 200.

The absolute location data may be generated by a GPS of the handheld computing devices 200. However, the GPS of all the handheld computing devices 200 may not be activated. Furthermore, GPS based location data may not be precise enough for determining the position of members of a crowd. In the following paragraphs, alternative means are described for generating the location data.

Referring now concurrently to FIGS. 1, 2 and 4A, a representation of a crowd 400 in a venue comprising seats 410 is illustrated. Each seat may be, without limitations, a chair, a bench, etc. A beacon 420 is associated to at least some of the seats 410 of the crowd 400 (FIG. 4A illustrates a configuration where each seat 410 is associated with a beacon 420, while FIG. 4B illustrates a configuration where only some of the seats 410 are associated with a beacon 420). The beacons 420 exchange radio signals with handheld computing devices (e.g. 201 to 205) in their vicinity. Each handheld computing device 201 to 205 detects a particular beacon 420, by filtering signals received from several beacons in its vicinity, to only keep the signals transmitted by the particular beacon 420 with the highest signal strength. The location of each of the beacons 420 (e.g. position of each seat 410 holding a beacon 420 with respect to the other seats 410) is stored in the memory 120 of the control system 100, along with a unique identifier of each beacon 420. Each handheld computing device 201 to 205 receives the unique identifier of its detected particular beacon 420, and transmits this identifier to the control system 100 as its location data. The control system 100 determines the location of each handheld computing device 201 to 205 with the absolute location data consisting of the unique identifiers of the beacons 420 transmitted by the handheld computing devices 201 to 205 and the location data of the beacons 420 stored in its memory 120. Alternatively, each handheld computing device 201 to 205 may transmit a unique identifier to the beacons 420, and each beacon 420 may transmit the unique identifier of its associated handheld computing device 201 to 205 to the control system 100. Then, each handheld computing device 201 to 205 is mapped to a particular beacon 420 (for which the control system 100 has absolute location data) via the transmitted unique identifier.

Referring now concurrently to FIGS. 1, 2 and 4B, an example is illustrated where one handheld computing device 201-A (having a beacon 420 associated to its corresponding seat 410) generates absolute location data, by means described in the foregoing paragraphs in relation to FIG. 4A. Handheld computing devices 202 to 205 are in the vicinity of handheld computing device 201-A, and do not generate absolute location data, because no beacons are associated to their respective seats. Therefore, the location data of the handheld computing devices 202 to 205 consist in relative location data, determined with respect to handheld computing device 201-A.

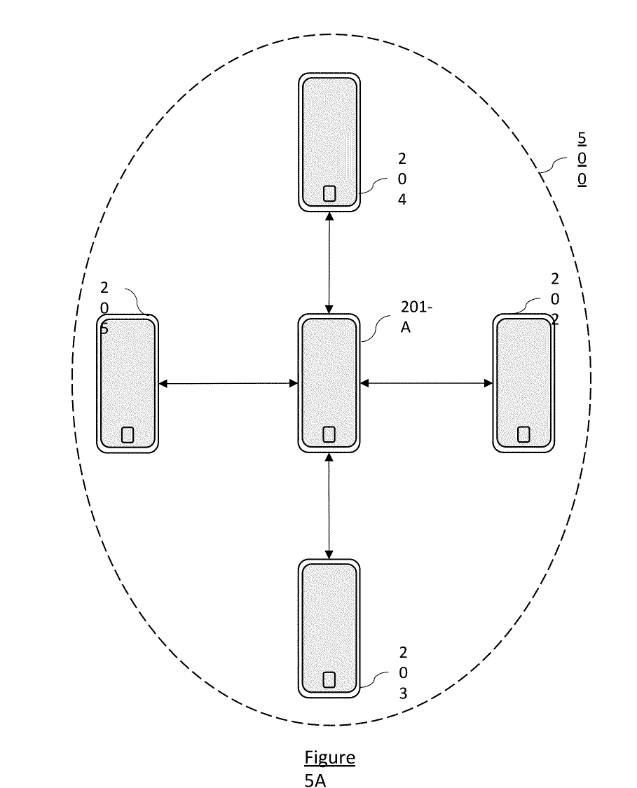

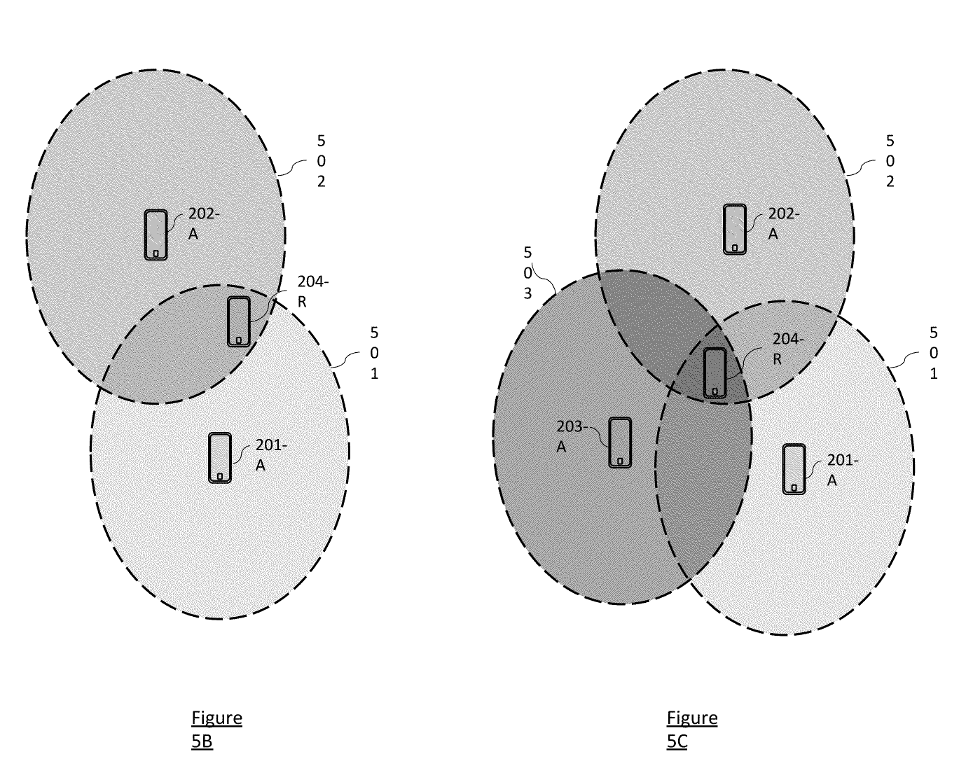

More precisely, relative location data of the handheld computing devices 202 to 205 are obtained by means of intercommunications (e.g. Bluetooth Low Energy (BLE) signals) between the handheld computing device 201-A and the handheld computing devices 202 to 205. Referring now to FIG. 5A, the handheld computing device 201-A is the center of a circle defining the circumference of a circular cluster 500 comprising the handheld computing devices 201-A and 202 to 205. Considering, for example, a crowd constituted of a multitude of handheld computing devices, then a plurality of circular clusters 500 is formed, each cluster 500 being centered on a handheld computing device generating absolute location data.

By filtering signals (e.g. BLE signals) received from surrounding handheld computing devices based on a signal strength threshold, the handheld computing device 201-A can determine that the handheld computing devices 202 to 205 are part of its cluster 500. This determination may not be sufficiently precise, since it does not allow to determine the exact position of the handheld computing devices 202 to 205 with respect to the handheld computing device 201-A. However, for certain types of interactions, the determination of the members of a cluster 500 centered on a handheld computing device 201-A generating absolute location data is sufficient. For example, to generate a wave in a crowd, it is sufficient for the control system 100 to send commands to all the members (e.g. handheld computing devices 201-A and 202 to 205) of one or several identified clusters 500, to propagate the wave from clusters to clusters.

To improve the determination of the location of the handheld computing devices 202 to 205, trilateration can be used. Trilateration is well known in the art, and consists in determining the position of a device by using three known references. Alternatively, two known references may be used, with a degradation in the precision of the determination of the location of the device. Therefore, it is possible to determine the location of handheld computing devices 202 to 205 with at least two clusters as illustrated in FIG. 5B, and preferably with three clusters as illustrated in FIG. 5C.

Referring to FIG. 5B, the handheld computing devices 201-A and 202-A are respectively the centers of the clusters 501 and 502. The location of the handheld computing device 204-R is determined by trilateration with respect to clusters 501 and 502. Alternatively, FIG. 5C illustrates three clusters 501, 502 and 503 having for respective centers the handheld computing devices 201-A, 202-A and 203-A. The location of the handheld computing device 204-R is determined by trilateration with respect to clusters 501, 502 and 503, with a better precision than the one obtained with two clusters as illustrated in FIG. 5B.

The determination of the relative location data is not limited to the usage of the BLE technology. The relative location data can be obtained through a mesh communication interface of the handheld computing devices, supporting any type of mesh networking technology allowing direct communications between the handheld computing devices (emission, reception and measurement of radio signals compliant with the particular mesh networking technology).

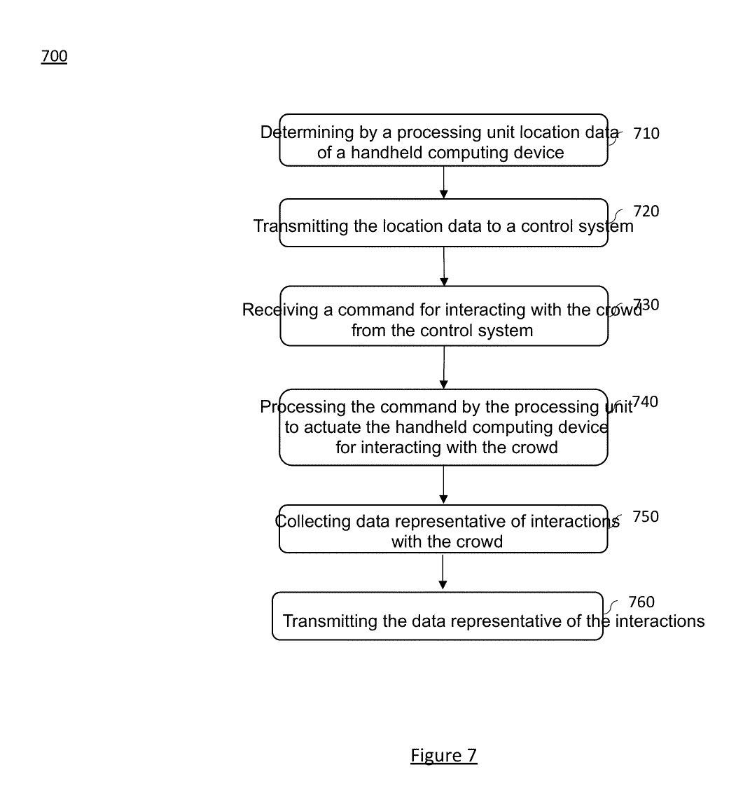

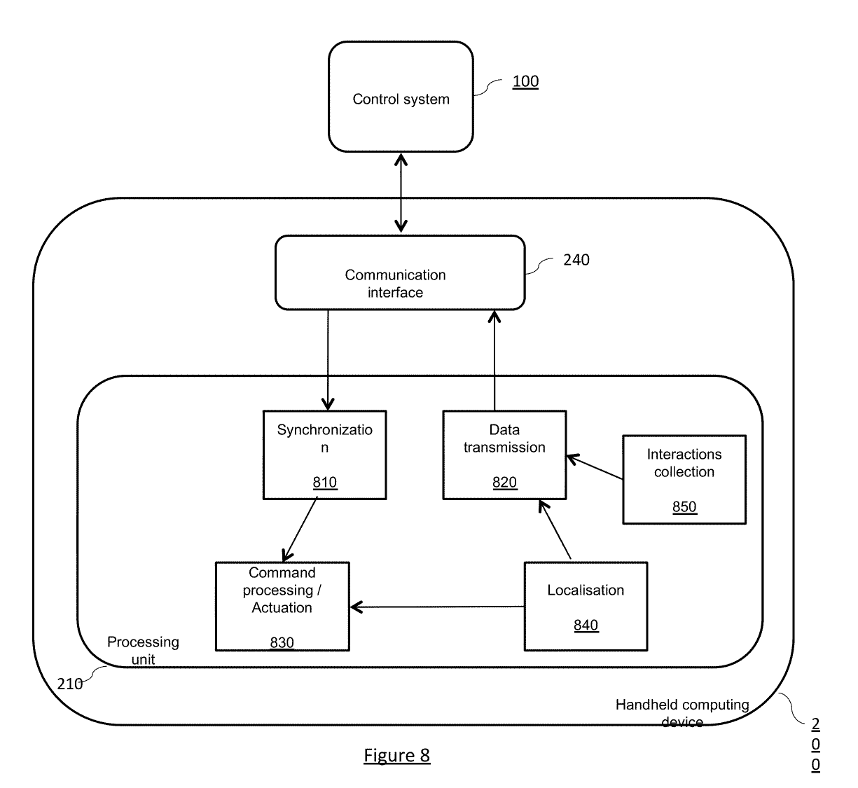

Referring now to FIGS. 7 and 8 concurrently, software components executed by the processing unit 210 of the handheld computing device 200 of FIG. 2 for implementing the method 700 of FIG. 7 are represented.

A synchronization component 810 implements step 730 of the method 700. A command processing and actuation component 830 implements step 740 of the method 700. A localization component 840 implements step 710 of the method 700. An interactions collection component 850 implements step 750 of the method 700. A data transmission component 820 implements steps 720 and 760 of the method 700.

The software components represented in FIG. 8 are for illustration purposes only. The steps of the method 700 may be implemented by an alternative combination of software components, based on specific implementation choices depending on a hardware configuration of the handheld computing device 200, its operating system, etc.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A system for locating members of a crowd and controlling interactions therewith, comprising:
memory for storing a scenario for interacting with the crowd, the scenario comprising at least one step;
a communication interface for:
receiving location data from a plurality of handheld computing devices of the crowd; and
receiving data representative of interactions with the crowd;
a processing unit for:
processing the location data and a specific step of the scenario to:
generate a command for interacting with the crowd, and
identify specific handheld computing devices among the plurality of handheld computing devices for applying the command;
transmitting via the communication interface the command to the specific handheld computing devices; and
processing the data representative of the interactions with the crowd.

2. The system of claim 1, further comprising at least one display, and wherein the processing unit generates a command for interacting with the crowd based on a specific step of the scenario and the command is displayed on the at least one display.

3. The system of claim 1, wherein at least one step of the scenario comprises a time reference, and the time reference is transmitted with the command.

4. The system of claim 1, wherein the data representative of the interactions with the crowd are received from the plurality of handheld computing devices.

5. The system of claim 1, wherein the data representative of the interactions with the crowd are received from at least one sensor.

6. The system of claim 1, wherein the generation of the command for interacting with the crowd and the identification of the specific handheld computing devices for applying the command take into consideration the data representative of the interactions with the crowd.

7. The system of claim 1, wherein each of the plurality of handheld computing devices has a unique identifier, the location data of a particular handheld computing device comprises the unique identifier of the particular handheld computing device, and the identification of specific handheld computing devices among the plurality of handheld computing devices for applying the command is based on the unique identifiers of the specific handheld computing devices.

8. A method for locating members of a crowd and controlling interactions therewith, comprising:
storing at a memory a scenario for interacting with the crowd, the scenario comprising at least one step;
receiving location data from a plurality of handheld computing devices of the crowd;
processing by a processing unit the location data and a specific step of the scenario to:
generate a command for interacting with the crowd, and
identify specific handheld computing devices among the plurality of handheld computing devices for applying the command;
transmitting the command to the specific handheld computing devices;
receiving data representative of interactions with the crowd; and
processing by the processing unit the data representative of the interactions with the crowd.

9. The method of claim 8, wherein processing the data representative of the interactions with the crowd comprises generating a visual representation of the interactions with the crowd, the visual representation being further displayed.

10. The method of claim 8, further comprising generating by the processing unit a command for interacting with the crowd based on a specific step of the scenario and displaying the command on at least one display.

11. The method of claim 8, wherein at least one step of the scenario comprises a time reference, and the time reference is transmitted with the command.

12. The method of claim 8, wherein the data representative of the interactions with the crowd are received from at least one of the following: the plurality of handheld computing devices, and at least one sensor.

13. The method of claim 8, wherein the generation of the command for interacting with the crowd and the identification of the specific handheld computing devices for applying the command take into consideration the data representative of the interactions with the crowd.

14. The method of claim 8, wherein each of the plurality of handheld computing devices has a unique identifier, the location data of a particular handheld computing device comprises the unique identifier of the particular handheld computing device, and the identification of specific handheld computing devices among the plurality of handheld computing devices for applying the command is based on the unique identifiers of the specific handheld computing devices.

15. A computer program product comprising instructions deliverable via an electronically-readable media, such as storage media and communication links, which when executed by a processing unit of a handheld computing device provide for locating members of a crowd and controlling interactions therewith by:
determining location data of the handheld computing device;
transmitting the location data to a control system;
receiving a command for interacting with the crowd from the control system;
processing the command to actuate the handheld computing device for interacting with the crowd;
collecting data representative of interactions with the crowd; and
transmitting the data representative of the interactions with the crowd to the control system.

16. The computer program product of claim 15, wherein the location data comprise at least one of the following: absolute location data, and relative location data representative of a position of the handheld computing device with respect to at least one other handheld computing device.

17. The computer program product of claim 16, wherein the relative location data are obtained through a mesh communication interface of respectively the handheld computing device and the at least one other handheld computing device.

18. The computer program product of claim 15, wherein actuating the handheld computing device for interacting with the crowd comprises at least one of the following: displaying the command on a display of the handheld computing device, and activating a component of the handheld computing device.

19. The computer program product of claim 15, wherein the command comprises a time reference, and the actuation of the handheld computing device for interacting with the crowd is performed based on the time reference.

20. The computer program product of claim 15, wherein the handheld computing device has a unique identifier, and the location data and the data representative of interactions with the crowd comprise the unique identifier.
